(19) United States
(12) Patent Application Publication
(10) Pub. No.: US 2023/0368162 A1
(43) Pub. Date: Nov. 16, 2023

(54) CONTROL METHOD, SERVER, AND RECORDING MEDIUM

(71) Applicant: Panasonic Intellectual Property Corporation of America, Torrance, CA (US)

(72) Inventor: Naohisa NISHIDA, Osaka (JP)

(21) Appl. No.: 18/225,842

(22) Filed: Jul. 25, 2023

Related U.S. Application Data
(63) Continuation of application No. PCT/JP2022/001771, filed on Jan. 19, 2022.
(60) Provisional application No. 63/142,619, filed on Jan. 28, 2021.

(51) Int. Cl. G06Q 20/10; G06Q 40/02

(52) U.S. Cl. CPC G06Q 20/10; G06Q 40/02

(57) ABSTRACT

An authentication server acquires and stores first transaction data in a distributed ledger, the first transaction data indicating a transfer of a first amount as a remaining transfer amount from a first account of a first user to a second account of a second user, and executes a first program. When the first amount is greater than a second amount indicating a balance in the first account, the first program transfers the second amount to the second account. The authentication server acquires and stores second transaction data in the distributed ledger, the second transaction data indicating a transfer of a fourth amount from a third account of a third user to the first account, and executes a second program. The second program transfers the fourth amount from the third account to the first account, and the first program transfers all or part of the fourth amount to the second account.

### CROSS REFERENCE TO RELATED APPLICATIONS

This is a continuation application of PCT International Application No. PCT/JP2022/001771 filed on Jan. 19, 2022, designating the United States of America, which is based on and claims priority of U.S. Provisional Patent Application No. 63/142,619 filed on Jan. 28, 2021. The entire disclosures of the above-identified applications, including the specifications, drawings and claims are incorporated herein by reference in their entirety.

### FIELD

The present disclosure relates to a control method, a server, and a recording medium.

### BACKGROUND

For example, Patent Literature (PTL) 1 discloses a method of using smart contract technology to automatically execute transaction procedures.

### CITATION LIST

### Patent Literature

PTL 1: International Publication No. 2019/003414

### SUMMARY

### Technical Problem

The aforementioned conventional technology, however, has a problem in that a disbursement to an exporter is not transferred properly when the disbursement exceeds a transferable deposit balance of an importer.

The present disclosure has been made in light of the aforementioned circumstances, and it is an object of the present disclosure to provide a control method or the like that allows transfers to proceed properly depending on the status of each person who has to make a transfer.

### Solution to Problem

To achieve the object described above, a control method according to the present disclosure is a control method for controlling a server that manages a transaction by using a distributed ledger. The control method includes acquiring first transaction data by the server, the first transaction data indicating a transfer of a first amount from a first account of a first user to a second account of a second user, the first amount indicating a remaining transfer amount, storing the first transaction data in the distributed ledger by the server, executing a first smart contract by the server upon storage of the first transaction data in the distributed ledger, determining whether the first amount is greater than a second amount that indicates a balance in the first account and transferring the second amount to the second account when the first amount is greater than the second amount, the determining and the transferring being performed by the first smart contract, acquiring second transaction data and storing the second transaction data in the distributed ledger by the server, the second transaction data indicating a transfer of a fourth amount from a third account of a third user to the first account, the third user being different from the first user and the second user, executing a second smart contract by the server upon storage of the second transaction data in the distributed ledger, transferring the fourth amount from the third account to the first account by the second smart contract, and transferring all or part of the fourth amount to the second account by the first smart contract.

It is to be noted that such a generic or specific embodiment of the present disclosure may be embodied in a system, a method, an integrated circuit, a computer program, or a computer-readable recording medium such as a CD-ROM, or may be embodied in any combination of a system, a method, an integrated circuit, a computer program, and a recording medium.

### Advantageous Effects

According to the present disclosure, it is possible to achieve a control method or the like that allows transfers to proceed properly depending on the account status of each person who has to make a transfer.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram showing one example of an overall configuration of a payment control system according to an embodiment.

FIG. 2 is a block diagram showing one example of a configuration of a terminal according to the embodiment.

FIG. 3 is a block diagram showing one example of a configuration of an authentication server according to the embodiment.

FIG. 4 is a diagram showing one example of a variable and a function that are used in a payment smart contract according to the embodiment.

FIG. 5 is a diagram showing one example of a variable and functions that are used in a payment SC management smart contract according to the embodiment.

FIG. 6 is a flowchart showing one example of operations of the authentication server according to the embodiment.

FIG. 7A is a diagram showing a sequence of operations of the payment control system according to the embodiment.

FIG. 7B is a diagram showing a sequence of operations of the payment control system according to the embodiment.

FIG. 8 is a flowchart showing the details of the operation performed in step S16 in FIG. 7A.

FIG. 9 is a diagram showing one example of a list managed by the payment SC management smart contract according to the embodiment.

FIG. 10 is a diagram showing one example of the details of the operation performed in step S168 in FIG. 8.

FIG. 11 is a diagram showing one example of a list managed by the payment SC management smart contract according to the embodiment.

FIG. 12 is a flowchart showing the details of the operation performed in step S26 in FIG. 7B.

FIG. 13 is a diagram showing one example of a list managed by the payment SC management smart contract according to a different variation.

### DESCRIPTION OF EMBODIMENTS

A control method according to one embodiment of the present disclosure is a control method for controlling a server that manages a transaction by using a distributed ledger. The control method includes acquiring first transaction data by the server, the first transaction data indicating a transfer of a first amount from a first account of a first user to a second account of a second user, the first amount indicating a remaining transfer amount, storing the first transaction data in the distributed ledger by the server, executing a first smart contract by the server upon storage of the first transaction data in the distributed ledger, determining whether the first amount is greater than a second amount that indicates a balance in the first account and transferring the second amount to the second account when the first amount is greater than the second amount, the determining and the transferring being performed by the first smart contract, acquiring second transaction data and storing the second transaction data in the distributed ledger by the server, the second transaction data indicating a transfer of a fourth amount from a third account of a third user to the first account, the third user being different from the first user and the second user, executing a second smart contract by the server upon storage of the second transaction data in the distributed ledger, transferring the fourth amount from the third account to the first account by the second smart contract, and transferring all or part of the fourth amount to the second account by the first smart contract.

In this way, even if the remaining transfer amount is greater than the balance in the first account of the first user who has to make a transfer, it is possible to cause the first user to once transfer the total amount in the first account and then, when money is added into the account of the first user, transfer part or all of the amount added to the first account. That is, even if the remaining transfer amount exceeds a transferable balance in the account of the first user, it is possible by using the smart contract technology to cause the first user to later transfer the exceeded amount when money is added into the account of the first user.

This allows transfers to proceed properly depending on the account status of each person who has to make a transfer.

Alternatively, when the first amount is greater than the second amount, the first smart contract may transfer the second amount to the second account and calculate a third amount by deducting the second amount from the first amount as a remaining transfer amount to be transferred to the second user. After calculation of the third amount, the first smart contract may execute a management smart contract stored in the distributed ledger, the management smart contract being a contract to manage a list on memory, the list including, as variables, information on a transfer source, information on a transfer destination, and information on a smart contract to make a transfer from the transfer source to the transfer destination, and the management smart contract may add remaining transfer information to the list, the remaining transfer information being information in which a first address indicating the first user, a second address indicating the second user, an address indicating the first smart contract, and information indicating that the first user needs to transfer the third amount as the remaining transfer amount to the second user are associated with one another.

In this way, the management smart contracts different from the smart contract is used to execute transfers. This allows management of remaining transfer amounts and smart contracts to execute transfers of the remaining transfer amounts.

Alternatively, when the fourth amount is transferred to the first account, the second smart contract may execute the management smart contract, the management smart contract may confirm whether the list includes the remaining transfer information on the first user and, when the list includes the remaining transfer information on the first user, the management smart contract may notify the second smart contract of the first smart contract that corresponds to the remaining transfer information on the first user, and the second smart contract may execute the first smart contract in accordance with a result of notification from the management smart contract.

In this way, a smart contract that executes a given transfer executes the management smart contract so as to cause the management smart contract to identify a smart contract that executes a different transfer and acquire information such as the address of the smart contract that executes the different transfer. Then, the smart contract that executes the given transfer executes the smart contract that executes the different transfer. That is, smart contracts are executed in chained sequence by using the smart contract technology. This allows transfers to proceed properly depending on the account status of each person who has to make a transfer.

Here, for example, when the third amount is smaller than the fourth amount that has become the balance in the first account, the first smart contract may transfer the third amount to the second account.

Accordingly, it is possible by using the first smart contract executed in chained sequence to complete the transfer of the remaining transfer amount.

Alternatively, for example, when having confirmed that a remaining transfer amount to be transferred by the first user becomes zero as a result of the transfer of the third amount to the second account by the first smart contract, the management smart contract may delete the remaining transfer information on the first user from the list.

This avoids the first smart contract that has completed the transfer from being executed in chained sequence.

Alternatively, when the third amount is greater than the fourth amount that has become the balance in the first account, the first smart contract may transfer the fourth amount to the second account.

In this way, if the updated remaining transfer amount exceeds the balance with the money added into the account of the first user, it is possible by using the first smart contract to cause the first user to once transfer the total amount of the balance in the first account.

The use of the management smart contract allows management of remaining transfer amounts and smart contracts that execute transfers of the remaining transfer amounts.

Alternatively, when the third amount is greater than the fourth amount, the first smart contract may transfer the fourth amount to the second account and calculates a fifth amount by deducting the fourth amount from the third amount as a remaining transfer amount to be transferred to the second user. After calculation of the fifth amount, the first smart contract may execute the management smart contract, and the management smart contract may update the list in accordance with remaining transfer information in which the first address indicating the first user, the second address indicating the second user, the address indicating the first smart contract, and information indicating that the first user needs to transfer the fifth amount as the remaining transfer amount to the second user are associated with one another.

Alternatively, the remaining transfer information included in the list may further include an order of priority, and when the list includes two or more remaining transfer information items on one user, the management smart contract may execute smart contracts, starting from a smart contract that corresponds to remaining transfer information with a highest order of priority.

Alternatively, an interest incurred for each predetermined period of time may be added to the remaining transfer amount.

A server according to one embodiment of the present disclosure is a server for managing a transaction by using a distributed ledger. The server includes a processor and memory. Using the processor and the memory, the server acquires first transaction data that indicates a transfer of a first amount from a first account of a first user to a second account of a second user, the first amount indicating a remaining transfer amount, stores the first transaction data in the distributed ledger, executes a first smart contract upon storage of the first transaction data in the distributed ledger, causes the first smart contract to determine whether the first amount is greater than a second amount that indicates a balance in the first account and transfer the second amount to the second account when the first amount is greater than the second amount, causes the processor to acquire second transaction data and store the second transaction data in the distributed ledger, the second transaction data indicating a transfer of a fourth amount from a third account of a third user to the first account, the third user being different from the first user and the second user, causes the processor to execute a second smart contract upon storage of the second transaction data in the distributed ledger, causes the second smart contract to transfer the fourth amount from the third account to the first account, and causes the processor to cause the first smart contract to transfer all or part of the fourth amount to the second account.

Hereinafter, an embodiment is described with reference to the drawings. It is to be noted that the embodiment described below is one specific example of the present disclosure. Therefore, numerical values, constituent elements, the arrangement and connection of constituent elements, steps, the sequence of the steps, and so on shown in the following embodiment are mere examples of the present disclosure and do not intend to limit the scope of the present disclosure. Among the constituent elements in the following embodiment, those that are not recited in any of the independent claims which define the generic concept of the present disclosure are described as arbitrary constituent elements. The embodiment of the present disclosure is not intended to be limited to the current independent claims and may also be embodied in any other independent claim.

### Embodiment 1

### 1. System Configuration

Hereinafter a payment control system or the like according to an embodiment is described with reference to the drawings.

The payment control system according to the present embodiment uses smart contract technology so as to allow payments to proceed properly depending on the account status of each person who has to make a payment. Note that the term “payment” can also refer to “transfer”. The following description is given on the assumption that a person who has to make a payment is referred to as a first user, a person who receives a payment from the first user is referred to as a second user, and payments are made via tokens. The payment according to the present disclosure refers to a forced payment such as indemnities, but the present disclosure is not limited to this example. If persons and accounts can be made in one-to-one correspondence, the payment according to the present disclosure may refer to the payment of a price of a product purchased by the first user, or may for example be the payment of a price to be paid after a product ordered by the first user is completed.

### [1.1. Overall Configuration of Payment Control System 10]

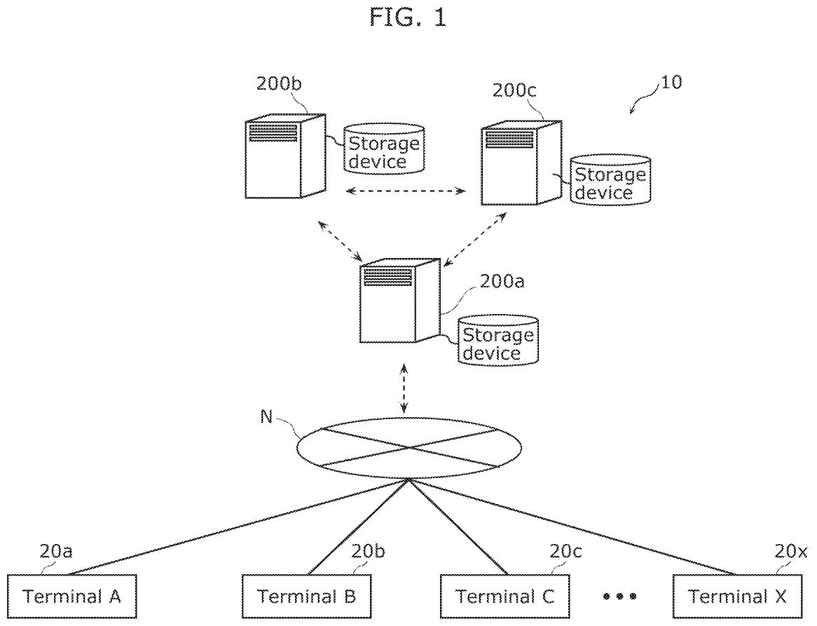

FIG. 1 is a diagram showing one example of an overall configuration of payment control system 10 according to the present embodiment.

As illustrated in FIG. 1, payment control system 10 includes terminals 20a to 20x and authentication servers 200a, 200b, and 200c. These terminals and servers are connected to one another via network N.

Network N may, for example, be the Internet and may be configured by any communication line or network.

In the following description, terminals 20a to terminal 20x may also be referred to as terminals 20, or may also be referred to as terminals A to X. The following description is given on the assumption that terminal 20a is used by a first user, terminal 20b is used by a second user, and terminal 20c is used by a third user different from the first and second users. Each of authentication servers 200a, 200b, and 200c may also be referred to as authentication server 200. Each of authentication servers 200a, 200b, and 200c is connected to a storage device that includes a distributed ledger on which transaction data and blocks in a block chain are electronically recorded. Note that authentication servers 200a, 200b, and 200c may be connected to the storage devices via network N, or may include the storage devices therein.

Although one example of the case in which payment control system 10 includes the three authentication servers 200 is shown in FIG. 1, the present disclosure is not limited to this example. That is, payment control system 10 may include four or more authentication servers 200.

Next, one example of a configuration of one terminal 20 will be described.

### [1.2. Configuration of Terminal 20]

Terminal 20 is one example of equipment used by a user according to the present disclosure. For example, terminal 20 may be a personal computer, or may be a mobile terminal such as a smartphone or a tablet. Terminal 20 is implemented by a processor using memory to execute a predetermined program. Note that terminals 20, i.e., terminals 20a to 20x, have similar configurations.

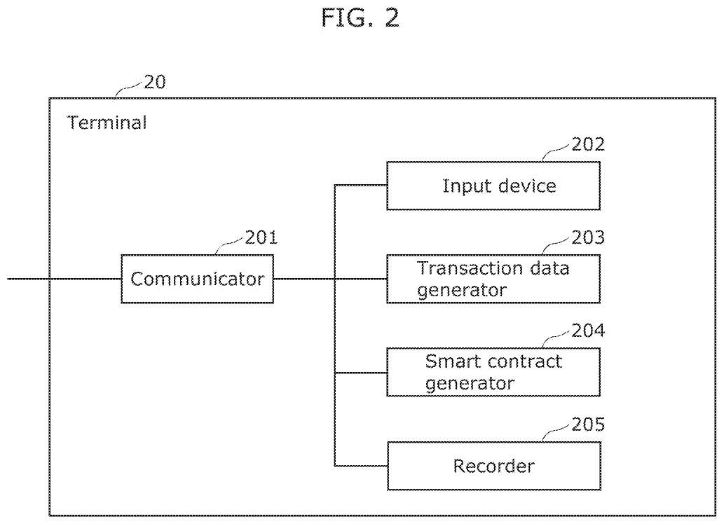

FIG. 2 is a block diagram showing one example of the configuration of terminal 20 according to the present embodiment.

In the present embodiment, terminal 20 includes communicator 201, input device 202, transaction data generator 203, smart contract generator 204, and recorder 205 as illustrated in FIG. 2.

### [1.2.1 Communicator 201]

Communicator 201 performs communication with authentication servers 200 via network N. The communication may be embodied in Transport Layer Security (TLS). In this case, communicator 201 may hold a cryptographic key for TLS communication.

In the present embodiment, for example, upon receipt of information from any authentication server 200, communicator 201 records the information in recorder 205 and notifies input device 202 of the fact. Communicator 201 also transmits transaction data generated by transaction data generator 203 to authentication servers 200.

### [1.2.2 Input Device 202]

Input device 202 accepts input of information by a user operation. Input device 202 displays the accepted input of information or transmits the accepted information to transaction data generator 203, smart contract generator 204, or communicator 201.

In the present embodiment, when terminal 20 is terminal 20a used by the first user, input device 202 accepts input of information indicating that, upon receipt of an operation from the first user, the remaining payment amount is paid from a first account of the first user to a second account of the second user. In this case, input device 202 transmits the accepted information to transaction data generator 203. The remaining payment amount as used herein refers to a gross amount (disbursement) that has to be paid by the first user.

When terminal 20 is terminal 20b used by the second user, input device 202 accepts input of information by an operation from the second user, the information being used to generate a smart contract that pays the remaining payment amount from the first account of the first user to the second account of the second user. In this case, input device 202 transmits the accepted information to smart contract generator 204. Note that the first user who uses terminal 20a may input the information for use in generating a smart contract that is programmed to be capable of executing the payment of the remaining payment amount from the first account of the first user to the second account of the second user.

Similarly, when terminal 20 is terminal 20c used by the third user, input device 202 accepts input of information by an operation from the third user, the information indicating the payment of a predetermined amount from a third account of the third user to the first account of the first user. In this case, input device 202 transmits the accepted information to transaction data generator 203. Note that, by an operation from the third user, input device 202 may accept input of information for use in generating a smart contract that pays the remaining payment amount from the third account of the third user to the first account of the first user. In this case, input device 202 transmits the accepted information to smart contract generator 204. Note that the first user who uses terminal 20a may input the information for use in generating a smart contract that is programmed to be capable of executing the payment of the remaining payment amount from the third account of the third user to the first account of the first user.

### [1.2.3 Transaction Data Generator 203]

Transaction data generator 203 generates transaction data to be used in block chain technology. More specifically, transaction data generator 203 generates transaction data in accordance with the information accepted by input device 202. Note that transaction data generator 203 may further generate transaction data provided with an identifier. Transaction data generator 203 may use a user-specific signature-generating key to generate a signature. Transaction data generator 203 may also generate transaction data that includes a smart contract generated by smart contract generator 204.

Transaction data generator 203 records the generated transaction data on recorder 205. Transaction data generator 203 transmits the generated transaction data to authentication server 200 via communicator 201.

In the present embodiment, for example, when terminal 20 is terminal 20b used by the second user, transaction data generator 203 generates transaction data that includes a first smart contract generated by smart contract generator 204.

For example, when terminal 20 is terminal 20a used by the first user, transaction data generator 203 generates first transaction data that indicates the payment of a first token amount indicating the remaining payment amount from the first account of the first user to the second account of the second user. Note that the term “token amount” can also refer to “amount”. When the first smart contract is generated by terminal 20a, transaction data generator 203 generates transaction data that includes the first smart contract generated by smart contract generator 204.

For example, when terminal 20 is terminal 20c used by the third user, transaction data generator 203 generates second transaction data that indicates the payment of a fourth token amount from the third account of the third user different from the first and second users to the first account. When the second smart contract is generated by terminal 20c, transaction data generator 203 generates transaction data that includes the second smart contract generated by smart contract generator 204.

### [1.2.4 Smart Contract Generator 204]

Smart contract generator 204 generates a smart contract to be used in the block chain technology. More specifically, smart contract generator 204 generates a smart contract in accordance with the information accepted by input device 202. The smart contract as used herein refers to a program executable in the block chain.

In the present embodiment, for example, when terminal 20 is terminal 20a used by the first user, smart contract generator 204 generates a first smart contract that is a payment smart contract that makes a payment from the first account of the first user to the second account of the second user. For example, when terminal 20 is terminal 20c used by the third user, transaction data generator 203 generates a second smart contract that is a payment smart contract that makes a payment from the third account of the third user different from the first and second users to the first account.

### [1.2.5 Recorder 205]

Recorder 205 records information accepted by input device 202 or records transaction data generated by transaction data generator 203. Recorder 205 also records a payment smart contract generated by smart contract generator 204.

Next, one example of the configuration of authentication server 200 will be described.

### [1.3 Configuration of Authentication Server 200]

Authentication server 200 is one example of a server that manages token transactions by using a distributed ledger. Authentication server 200 is achieved by the processor using memory to execute a predetermined program. Note that other authentication servers 200, i.e., authentication servers 200a to 200c, also have similar configurations.

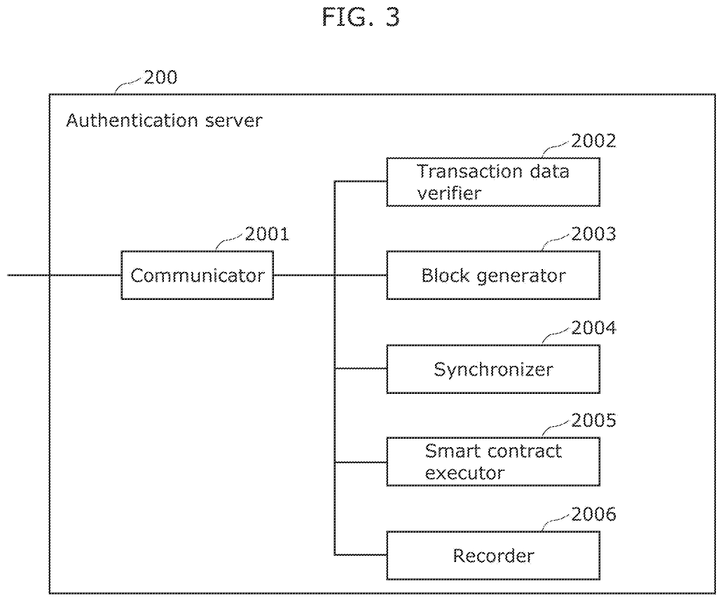

FIG. 3 is a block diagram showing one example of the configuration of authentication server 200 according to the present embodiment.

As illustrated in FIG. 3, authentication server 200 includes communicator 2001, transaction data verifier 2002, block generator 2003, synchronizer 2004, smart contract executor 2005, and recorder 2006. Each constituent element is described hereinafter.

### [1.3.1 Communicator 2001]

Communicator 2001 performs communication with terminals via network N. The communication may be implemented by TLS. In this case, communicator 2001 may hold a cryptographic key for TLS communication.

In the present embodiment, communicator 2001 acquires or transfers transaction data such as the first transaction data or the second transaction data from or to terminals 20. Communicator 2001 also acquires or transfers transaction data that includes a payment smart contract such as the first smart contract or the second smart contract from or to terminals 20. Communicator 2001 also acquires or transfers transaction data that includes a payment SC management smart contract from or to terminal 20 used by a servicer who manages payment control system 10. Note that the payment SC management smart contract is a smart contract different from smart contracts that execute payments, and is also a smart contract that manages remaining payment amounts and payment smart contracts to execute payments of the remaining payment amounts. The details of the payment SC management smart contract will be described later.

### [1.3.2 Transaction Data Verifier 2002]

Transaction data verifier 2002 verifies received transaction data. More specifically, upon acquisition of transaction data from terminal 20, transaction data verifier 2002 verifies whether the format of the transaction data is correct and whether the signature is correct.

In this way, transaction data verifier 2002 verifies acquired transaction data by confirming the correctness of the acquired transaction data.

When the correctness of the acquired transaction data is confirmed from the result of verification, transaction data verifier 2002 records the transaction data on recorder 2006. Here, when the transaction data is confirmed to be correct, transaction data verifier 2002 notifies synchronizer 2004 of this fact. When the correctness of the acquired transaction data is not confirmed, the transaction data may be discarded, and the processing for recording the transaction data in recorder 2006 may be omitted. This reduces unnecessary memory consumption and reduces the amount of processing performed by the processor.

### [1.3.3 Block Generator 2003]

When the verification of the transaction data by transaction data verifier 2002 has succeeded, block generator 2003 executes a consensus algorithm for the transaction data among the authentication servers 200. The consensus algorithm as used herein may be a consensus algorithm called Practical Byzantine Fault Tolerance (PBFT), or may be any other known consensus algorithm such as Proof of Work (PoW).

In the present embodiment, block generator 2003 executes a consensus algorithm among authentication servers 200a, 200b, and 200c. That is, block generator 2003 first generates a block in a block chain that includes one or more transaction data items. Then, block generator 2003 executes the consensus algorithm. When consensus development is found by execution of the consensus algorithm, block generator 2003 records the generated block on recorder 2006. The block generated by block generator 2003 is connected to the block chain stored in the distributed ledger by recorder 2006 and recorded on recorder 2006. When consensus development is not found as a result of the execution of the consensus algorithm, the generated block may be discarded, and the processing for recording the generated block in recorder 2006 may be omitted. This reduces unnecessary memory consumption and reduces the amount processing performed by the processor.

In the present embodiment, block generator 2003 includes transaction data such as the first transaction data or the second transaction data in the block and records the block on recorder 2006. Block generator 2003 also includes transaction data that includes a payment smart contract such as the first smart contract or the second smart contract in the blocs and records the block on recorder 2006. Block generator 2003 also includes transaction data that includes a payment SC management smart contract in the block and records the block on recorder 2006.

### [1.3.4 Synchronizer 2004]

Synchronizer 2004 synchronizes the transaction data or the blocks in the block chain among authentication servers 200 (authentication servers 200a to 200c).

Synchronizers 2004 of authentication servers 200 achieve peer-to-peer synchronization of the transaction data included in the block chain. Then, each synchronizer 2004 records the synchronized transaction data in the block chain on recorder 2006. For example, when the correctness of the transaction data is verified by transaction data verifier 2002, synchronizer 2004 transfers the verified transaction data to other authentication servers 200. When verified transaction data is received from other authentication servers 200, synchronizer 2004 records the received verified transaction data on recorder 2006.

### [1.3.5 Recorder 2006]

Recorder 2006 includes transaction data in the blocks and stores the blocks in the distributed ledger of authentication server 200. Recorder 2006 also records a smart contract that is to be stored in the distributed ledger for operation. The distributed ledger may be configured inside recorder 2006, or may be configured inside an external storage device of authentication server 200.

When the correctness of the acquired transaction data is confirmed, recorder 2006 stores the block including the transaction data in the distributed ledger of authentication server 200. Note that the blocks in the block chain stored in the distributed ledger may be exhibited to terminals 20.

In the present embodiment, recorder 2006 stores transaction data such as the first transaction data or the second transaction data in the distributed ledger of authentication server 200. Moreover, for example, recorder 2006 stores a payment smart contract such as the first smart contract or the second smart contract in the distributed ledger of authentication server 200. Similarly, for example, recorder 2006 stores a payment SC management smart contract in the distributed ledger of authentication server 200.

### [1.3.6 Smart Contract Executor 2005]

Smart contract executor 2005 stores smart contracts stored in the distributed ledger in a working memory.

More specifically, when transaction data including a smart contract is stored in the distributed ledger, i.e., when a block including the transaction data is generated and stored in the distributed ledger, smart contract executor 2005 stores the smart contract in the working memory. This allows smart contract executor 2005 to execute the smart contract stored in the working memory.

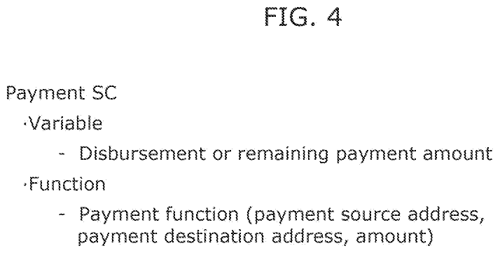

FIG. 4 is a diagram showing one example of a variable and a function that are used in the payment smart contract according to the present embodiment.

The payment smart contract refers to a smart contract that makes a payment from a payment source to a payment destination. As illustrated in FIG. 4, the payment smart contract includes a disbursement or a payment balance as a variable and executes a payment function so that a token amount indicated by the variable is paid from the payment source indicated by a payment source address to the payment destination indicated by a payment destination address. Note that the disbursement or the payment balance is referred to as a remaining payment amount in the present embodiment.

In the present embodiment, smart contract executor 2005 executes a first smart contract as a payment smart contract that makes a payment from the first account of the first user to the second account of the second user. Smart contract executor 2005 also executes a second smart contract as a payment smart contract that makes a payment from the third account of the third user to the first account.

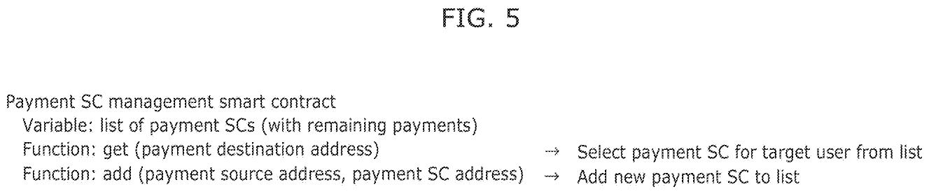

FIG. 5 is a diagram showing one example of a variable and functions that are used in the payment SC management smart contract according to the present embodiment.

The payment SC management smart contract refers to a smart contract that manages remaining payment amounts and payment smart contracts that pays the remaining payment amounts. More specifically, the payment SC management smart contract refers to a smart contract that manages a list on the memory, the list including, as variables, information on the payment source, information on the payment destination, and information on the smart contract that makes a payment from the payment source to the payment destination. The payment SC management smart contract is executed by the payment smart contract.

For example, as illustrated in FIG. 5, the payment SC management smart contract includes, as a variable, a list of payment smart contracts with remaining payment amounts and executes either a get function that is used to acquire the value of the variable or an add function that is used to add the value of the variable. By executing the get function, the payment SC management smart contract acquires information on a payment smart contract for a target user from the list managed on the memory. The target user as used herein refers to a user who has completed the payment and who indicates the payment source indicated by the payment source address included in the payment smart contract that has executed the payment SC management smart contract. The information on the payment smart contract may, for example, be a contract address. After the execution of the get function, the payment SC management smart contract deletes the acquired payment smart contract for the target user from the list managed on the memory. Since the program is not executed as a result of deleting the transfer smart contract for the target user, it is possible to reduce the amount of processing performed by the processor and to reduce unnecessary memory consumption.

By executing the add function, the payment SC management smart contract also adds information on the payment smart contract with a remaining payment amount to the list managed on the memory. When executed by the payment smart contract with the remaining payment amount, the payment SC management smart contract executes the add function by using the address of the payment source and the address of the payment smart contract with the remaining payment amount. By executing the add function, the payment SC management smart contract adds information on the payment smart contract with the remaining payment amount, i.e., remaining payment information, to the list managed on the memory. The remaining payment information refers to information in which the address of the payment source, the address of the payment destination, the address of the payment smart contract with the remaining payment amount, and information indicating the remaining payment amount that needs to be paid from the payment source to the payment destination are associated with one another.

### 2. Operations

### [2.1. Outline of Operations of Authentication Server 200]

Next, an outline of operations performed by authentication server 200 with the above-described configuration will be described.

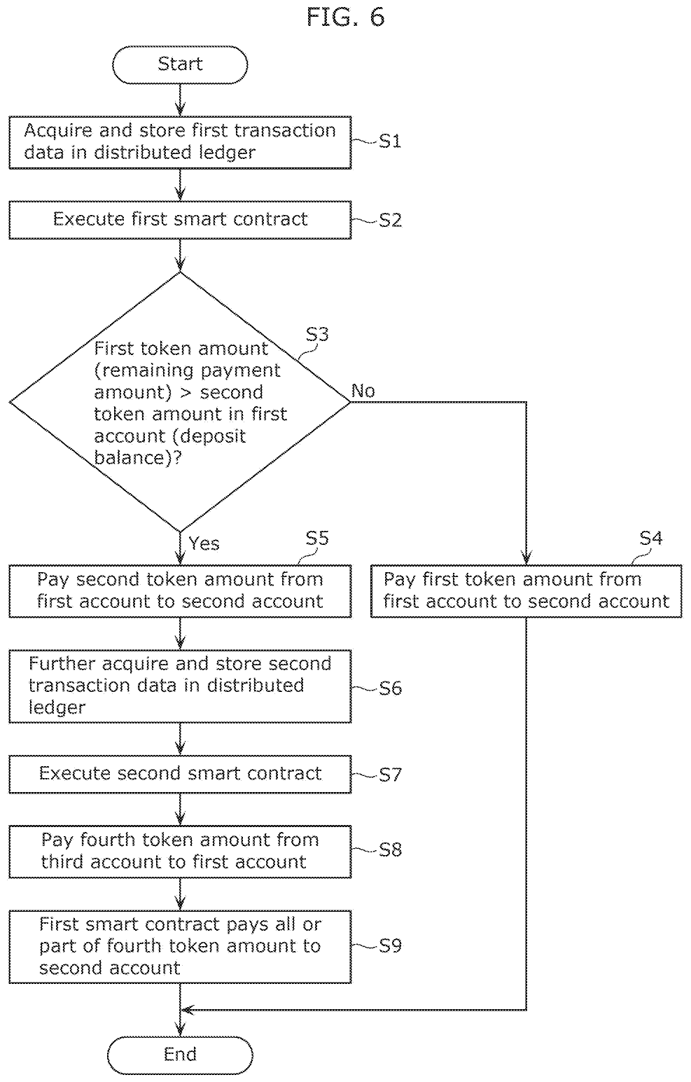

FIG. 6 is a flowchart showing one example of operations performed by authentication server 200 according to the present embodiment.

First, authentication server 200 acquires first transaction data from terminal 20 and stores the first transaction data in the distributed ledger (S1). More specifically, authentication server 200 acquires the first transaction data that indicates the payment of a first token amount indicating the remaining payment amount from the first account of the first user to the second account of the second user. Then, authentication server 200 stores the acquired first transaction data in the distributed ledger by, for example, executing a consensus algorithm.

Next, authentication server 200 executes a first smart contract (S2). More specifically, authentication server 200 executes the first smart contract upon storage of the first transaction data in the distributed ledger in step S1.

Next, the first smart contract determines whether the first token amount indicating the remaining payment amount is greater than a second token amount that indicates a deposit balance in the first account (S3). More specifically, the first smart contract determines whether the first token amount indicating the remaining payment amount of the first user is greater than the second token amount indicating the balance in the first account of the first user.

If the first token amount indicating the remaining payment amount is smaller than the second token amount indicating the deposit balance in the first account in step S3 (No in S3), the first smart contract pays the first token amount from the first account of the first user to the second account of the second user (S4).

On the other hand, if the first token amount is greater than the second token amount in the first account in step S3 (Yes in S3), the first smart contract pays the second token amount from the first account of the first user to the second account of the second user (S5).

Moreover, upon acquisition of the second transaction data from terminal 20, authentication server 200 stores the second transaction data in the distributed ledger (S6). More specifically, authentication server 200 is assumed to have acquired the second transaction data that indicates the payment of the fourth token amount from the third account of the third user different from the first and second users to the first account of the first user. Then, authentication server 200 stores the acquired second transaction data in the distributed ledger by, for example, executing a consensus algorithm.

Next, authentication server 200 executes the second smart contract (S7). More specifically, authentication server 200 executes the second smart contract upon storage of the second transaction data in the distributed ledger in step S6.

Next, the second smart contract pays the fourth token amount from the third account of the third user to the first account of the first user (S8).

Next, the first smart contract pays all or part of the fourth token amount paid to the first account of the first user to the second account of the second user (S9).

In this way, for example when the remaining payment amount to be paid to the second user exceeds the balance in the first account of the first user, authentication server 200 once makes a payment within a payable range from the first account to the second account. Then, when some sort of income is gained such as a payment from the third user to the first account of the first user, authentication server 200 is capable of causing the first user to automatically pay all or part of the income from the first account of the first user to the second account of the second user.

Accordingly, by using the smart contract technology, authentication server 200 is capable of properly making a payment depending on the account status of each person who has to make a payment.

### [2.2. Sequence of Operations of Payment Control System 10]

The following description is given of operations of payment control system 10 performed when properly making a payment depending on the account status of person A.

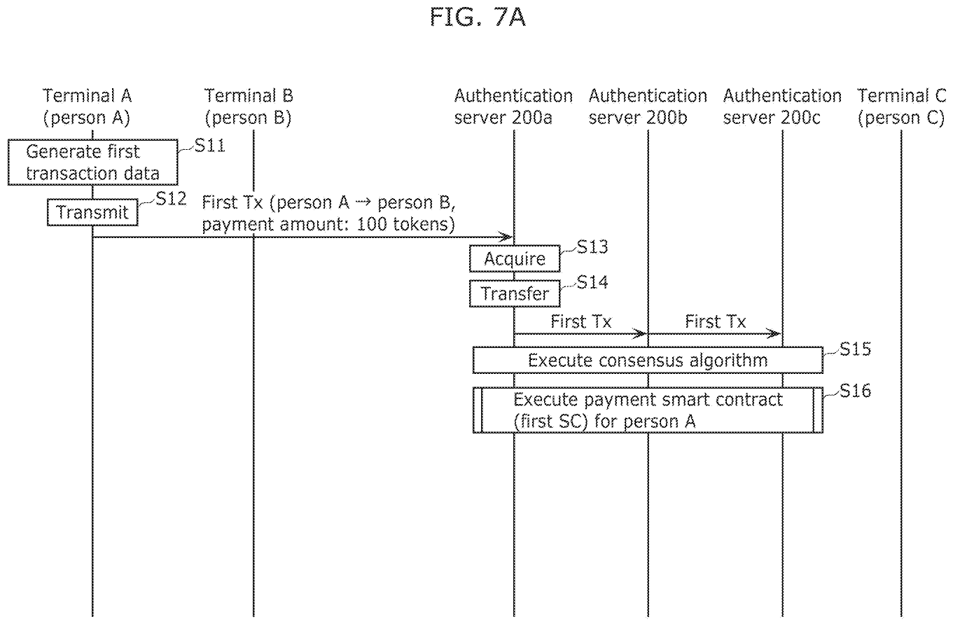

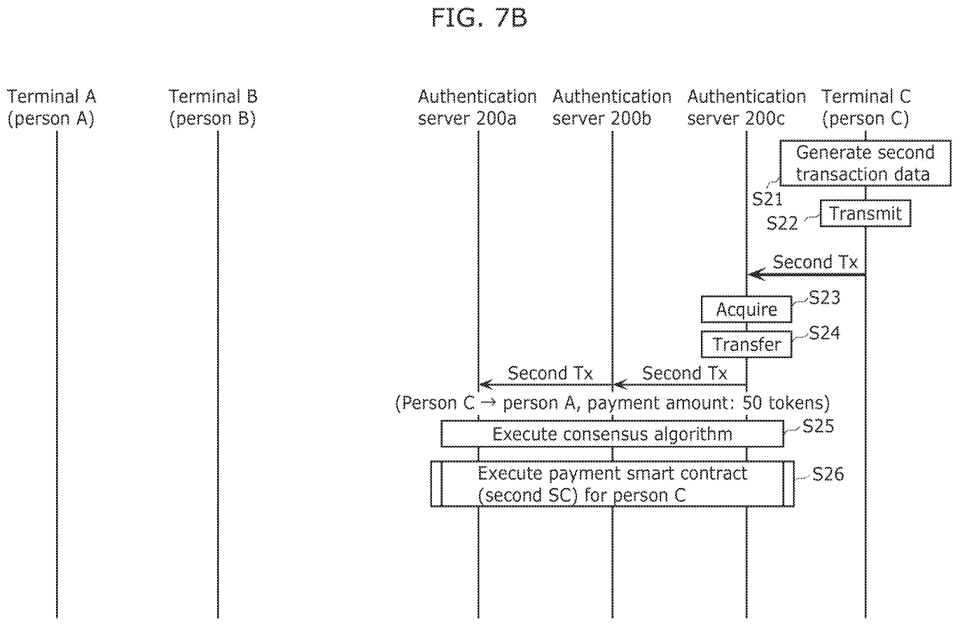

FIGS. 7A and 7B are diagrams showing a sequence of operations performed by payment control system 10 according to the present embodiment. Person A, person B, and person C in FIGS. 7A and 7B are one examples of the first user, the second user, and the third user, respectively. Terminal A corresponds to terminal 20a used by person A, terminal B corresponds to terminal 20b used by person B, and terminal C corresponds to terminal 20c used by person C.

First, terminal A generates first transaction data (S11). More specifically, person A uses terminal A to generate first transaction data that indicates the payment of, for example, 100 tokens as a disbursement from the account of person A to the account of person B. The disbursement may be referred to as the aforementioned remaining payment amount and means the gross amount that person A needs to pay to person B.

Next, terminal A transmits the first transaction data generated in step S11 to authentication server 200a (S12). Although terminal A transmits the generated first transaction data to authentication server 200a in the example illustrated in FIG. 7A, the first transaction data may be transmitted to authentication server 200b or 200c. This is because similar processing is performed even if the first transaction data is transmitted to authentication server 200b or 200c.

Next, authentication server 200a acquires the first transaction data transmitted in step S12 (S13).

Next, authentication server 200a transfers the first transaction data to other authentication servers 200b and 200c (S14). Note that authentication server 200a may verify the acquired first transaction data and transfer the first transaction data to other authentication servers 200b and 200c only when the verification has succeeded. In this case, other authentication servers 200b and 200c also verify the transferred first transaction data in the same manner.

Next, authentication server 200a executes a consensus algorithm together with authentication servers 200b and 200c (S15). More specifically, when authentication servers 200a, 200b, and 200c have verified that the acquired first transaction data is correct transaction data (i.e., correctness is verified), each authentication server generates a block that includes the first transaction data. Then, authentication servers 200a, 200b, and 200c store the block including the first transaction data in their distributed ledgers.

Next, authentication servers 200a, 200b, and 200c execute a payment smart contract for person A, stored in the distributed ledger (S16). The payment smart contract for person A is one example of the aforementioned first smart contract and is a smart contract that pays 100 tokens as the remaining payment amount from the account of person A to the account of person B in the example illustrated in FIG. 7A.

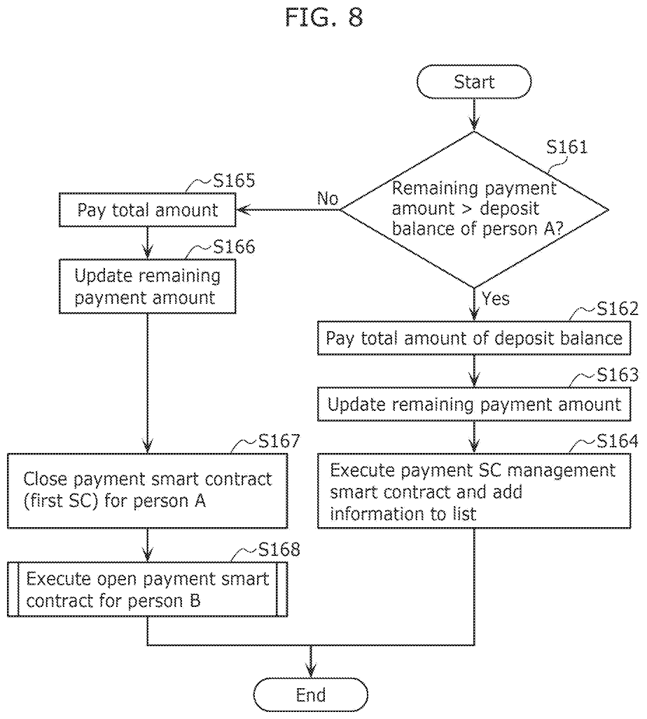

Here, the details of the operation performed in step S16 will be described with reference to FIG. 8.

FIG. 8 is a flowchart showing the details of the operation performed in step S16 in FIG. 7A.

In step S16, first, the payment smart contract for person A determines whether the remaining payment amount of 100 tokens is greater than the deposit balance of person A (S161).

If the remaining payment amount of 100 tokens is greater than the deposit balance of person A in step S161 (Yes in S161), the payment smart contract for person A pays the total amount of the deposit balance (S162). For example, when the deposit balance of person A is 80 tokens, the remaining payment amount of 100 tokens is greater than the deposit balance of 80 tokens of person A and therefore the payment smart contract for person A pays the deposit balance of 80 tokens of person A to the account of person B. In other words, when the first token amount indicating the remaining payment amount is greater than the second token amount indicating the deposit balance of the first user, the first smart contract pays the second token amount, which is the total amount of the deposit balance, to the second account of the second user.

Next, the payment smart contract for person A updates the remaining payment amount (S163). More specifically, the payment smart contract for person A makes a calculation of deducting the total amount of the deposit balance of 80 tokens from the remaining payment amount of 100 tokens to obtain 20 tokens as the remaining payment amount to be paid to person B. In other words, the first smart contract pays the second token amount indicating the deposit balance of the first user to the second account of the second user and calculates a third token amount by deducting the second token amount from the first token amount as the remaining payment amount to be paid to the second user.

Next, the payment smart contract for person A executes a payment SC management smart contract so as to cause the payment SC management smart contract to add information to the list (S164). More specifically, after the calculation of the remaining payment amount, the payment smart contract for person A executes the payment SC management smart contract. Then, the executed payment SC management smart contract adds remaining payment information to the list, the remaining payment information being information in which an address indicating person A, an address indicating person B, an address indicating the payment smart contract for person A, and information indicating that person A needs to pay 20 tokens to person B are associated with one another.

In other words, the first smart contract executes the payment SC management smart contract after the calculation of the third token amount. The payment SC management smart contract adds the remaining payment information to the list, the remaining payment information being information in which a first address indicating the first user, a second address indicating the second user, an address indicating the first smart contract, and information indicating that the first user needs to pay the third token amount as the remaining payment amount to the second user are associated with one another.

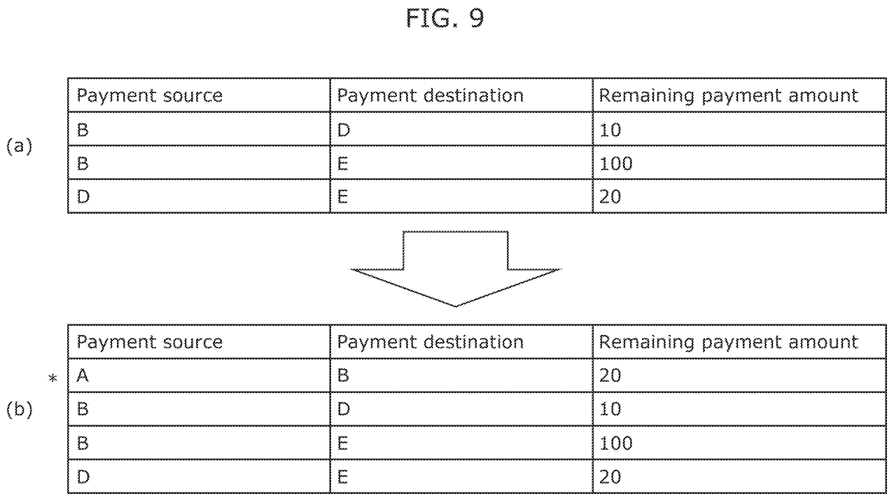

Here, one example of the case in which the remaining payment information is added to the list managed by the payment SC management smart contract will be described with reference to FIG. 9.

FIG. 9 is a diagram showing one example of the list managed by the payment SC management smart contract according to the embodiment. In FIG. 9, (a) shows one example of the list managed by the payment SC management smart contract before information is added to the list in step S164. In FIG. 9, (b) shows one example of the list managed by the payment SC management smart contract after information is added to the list in step S164. The row with an asterisk (*) illustrated in (b) in FIG. 9 indicates the row added to the list.

Referring to (a) in FIG. 9, the payment SC management smart contract manages, in the form of a list, the remaining payment information indicating that person B needs to pay 10 tokens to person D, person B needs to pay 100 tokens to person E, and person D needs to pay 20 tokens to person E. Note that a payment smart contract for person B that pays 10 tokens to person D and a payment smart contract for person B that pays 100 tokens to person E are not shown in (a) in FIG. 9. Similarly, a payment smart contract for person D that pays 20 tokens to person E is also not shown.

Referring then to (b) in FIG. 9, the remaining payment information indicating that person A needs to pay 20 tokens to person B is added to the list illustrated in (a) in FIG. 9. Note that the payment smart contract for person A that pays 20 tokens to person B is also not shown in (b) in FIG. 9.

Referring back to FIG. 8, the description is continued.

If the remaining payment amount of 100 tokens is smaller than the deposit balance of person A in step S161 (No in S161), on the other hand, the payment smart contract for person A pays all of the remaining payment amount (S165). For example, when the deposit balance of person A is 150 tokens, the deposit balance of 150 tokens of person A is greater than the remaining payment amount of 100 tokens. In this case, the payment smart contract for person A pays 100 tokens, out of the deposit balance of 150 tokens of person A, to the account of person B. In other words, when the first token amount indicating the remaining payment amount to be paid to the second user is smaller than the second token amount indicating the balance in the first account of the first user, the first smart contract pays the first token amount, out of the second token amount, to the second account of the second user.

Next, the payment smart contract for person A updates the remaining payment amount (S166). More specifically, the payment smart contract for person A updates the remaining payment amount that is to be paid to person B into zero because the payment of the remaining payment amount of 100 tokens to person B is completed.

Next, the payment smart contract for person A closes itself so as not to be executed afterward (S167) and executes an open payment smart contract for person B (S168).

Here, the details of the operation performed in step S168 will be described.

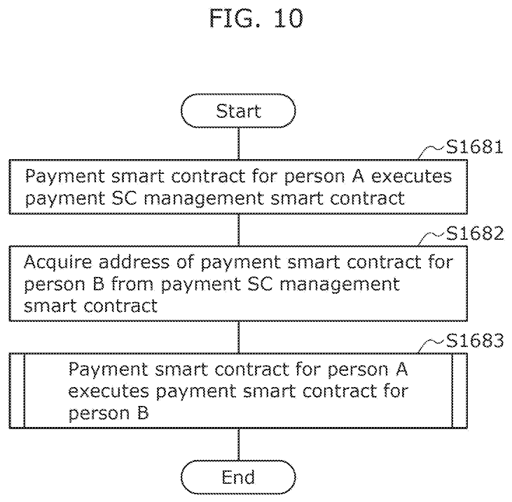

FIG. 10 is a diagram showing one example of the details of the operation performed in step S168 in FIG. 8.

In step S168, first, the payment smart contract for person A executes the payment SC management smart contract (S1681). More specifically, the first smart contract indicating the payment smart contract for person A closes itself so as not to be executed afterward and executes the payment SC management smart contract.

Next, the payment smart contract for person A acquires an address of a payment smart contract for person B from the payment SC management smart contract (S1682). More specifically, the executed payment SC management smart contract identifies (searches for), as a payment source, a payment smart contract that includes person B serving as the payment destination and returns the address of the payment smart contract for person B to the payment smart contract for person A. This allows the first smart contract that is the payment smart contract for person A to acquire the address of the payment smart contract for person B.

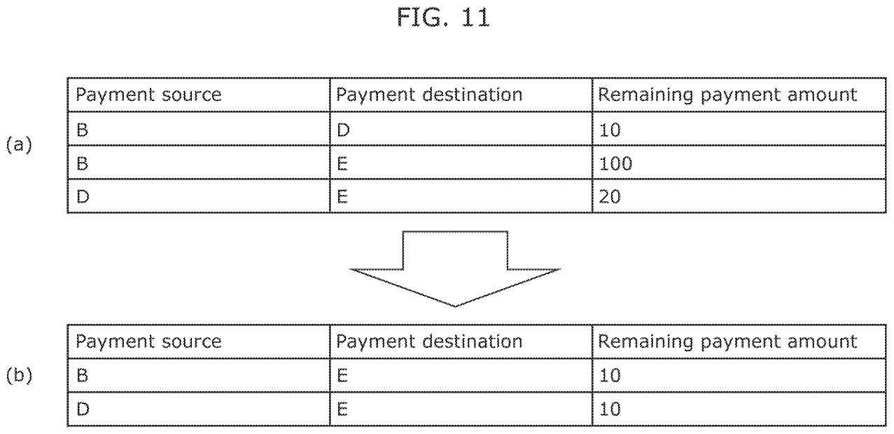

Next, the payment smart contract for person A executes the payment smart contract for person B (S1683). Here, a description of the payment smart contract for person B is omitted because the payment smart contract for person B performs operations similar to the operations performed by the payment smart contract for person A. As a result of execution of the payment smart contract for person B, the list managed by the payment SC management smart contract is changed (updated). Hereinafter, one example of the case in which the list managed by the payment SC management smart contract is changed will be described with reference to FIG. 11.

FIG. 11 is a diagram showing one example of the list managed by the payment SC management smart contract according to the embodiment.

In FIG. 11, (a) shows one example of the list managed by the payment SC management smart contract before step S1683 is performed. In FIG. 11, (b) shows one example of the resultant list managed by the payment SC management smart contract after step S1683 is performed. The example illustrated in (a) in FIG. 11 is the same as the example illustrated in (a) in FIG. 9, and therefore a description thereof is omitted.

In step S1683, first, a payment smart contract for person B that corresponds to the first row in the list illustrated in (a) in FIG. 11 is executed, and then a payment smart contract for person B that corresponds to the second row in the list illustrated in (a) in FIG. 11 is executed. This is because 100 tokens paid from person A are retained in the account of person B.

As a result, the remaining payment amount of 10 tokens to be paid to person D, which corresponds to the first row in the list illustrated in (a) in FIG. 11, is paid in full, and this first row is deleted from the list. Moreover, 90 tokens out of the remaining payment amount of 100 tokens to be paid to person E, which corresponds to the second row in the list illustrated in (a) in FIG. 11, are paid from person B to person E, and the remaining payment amount is updated.

Therefore, the remaining payment information in the first row in the list illustrated in (b) in FIG. 11 is updated to indicate that person B needs to pay 10 tokens to person E.

Since the remaining payment amount corresponding to the first row in the list illustrated in (a) in FIG. 11 has been paid in full, the payment smart contract for person B that corresponds to the first row performs processing similar to the processing in steps S167 and S168. That is, the payment smart contract for person B that corresponds to the first row executes a payment smart contract for person D. As a result, 10 tokens out of the remaining payment amount of 20 tokens to be paid to person E, which corresponds to the third row in the list illustrated in (a) in FIG. 11, are paid from person D to person E. As a result, the remaining payment amount to be paid to person E, which corresponds to the second row in the list illustrated in (b) in FIG. 11, is updated into 10 tokens.

In this way, payment smart contracts are executed in chained sequence by using the smart contract technology, i.e., using one or more payment smart contracts and the payment SC management smart contract. This allows payments to proceed properly depending on the account status of each person who has to make a payment.

Referring back to FIG. 7A, the description is continued. The example illustrated in FIG. 7A is described on the assumption that the payment smart contract for person A has once paid the deposit balance of 80 tokens of person A into the account of person B in step S16 because the remaining payment amount of 100 tokens exceeds the deposit balance of 80 tokens of person A.

Thereafter, terminal C is assumed to have generated second transaction data (S21) as illustrated in FIG. 7B. More specifically, person C uses terminal C to generate the second transaction data that indicates, for example, that 50 tokens are to be paid as a disbursement from the account of person C to the account of person A. The disbursement as used herein may also be referred to as the remaining payment amount as described above and means the gross amount that person C needs to pay to person A.

Next, terminal C transmits the second transaction data generated in step S21 to authentication server 200c (S22). Although, in the description of the example illustrated in FIG. 7B, terminal C transmits the generated second transaction data to authentication server 200c, the second transaction data may be transmitted to authentication server 200a or 200b. This is because similar processing is also performed even if the second transaction data is transmitted to authentication server 200a or 200b.

Next, authentication server 200c acquires the second transaction data transmitted in step S22 (S23).

Next, authentication server 200c transfers the second transaction data to other authentication servers 200a and 200b (S24). Note that authentication server 200c may verify the acquired second transaction data and transfer the second transaction data to other authentication servers 200a and 200b only when the verification has succeeded. In this case, other authentication servers 200a and 200b may also verify the second transaction data acquired by transfer in the same manner.

Next, authentication server 200c executes a consensus algorithm together with authentication servers 200a and 200c (S25). More specifically, when the acquired second transaction data has been verified as being correct (i.e., correctness is verified), authentication servers 200a, 200b, and 200c each generate a block that includes the second transaction data. Then, authentication servers 200a, 200b, and 200c each store the block including the second transaction data in their distributed ledger.

Next, authentication servers 200a, 200b, and 200c execute a payment smart contract for person C stored in the distributed ledger (S26). The payment smart contract for person C is one example of the aforementioned second smart contract and, in the example illustrated in FIG. 7B, a smart contract that pays 50 tokens from the account of person C to the account of person A.

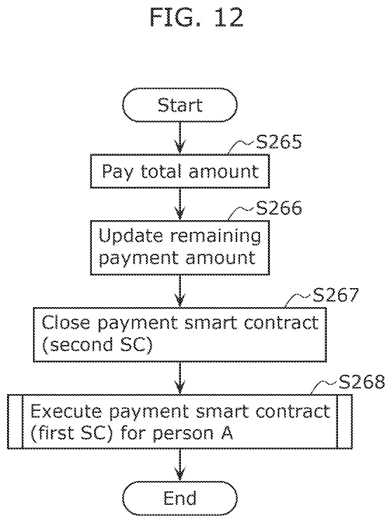

Here, the details of the operation performed in step S26 will be described with reference to FIG. 12.

FIG. 12 is a flowchart showing the details of the operation performed in step S26 illustrated in FIG. 7B.

In step S26, first, the payment smart contract for person C pays a total amount of 50 tokens from the account of person C to the account of person A (S265). Note that the payment smart contract for person C can be handled as similar to the other smart contracts by handling the disbursement of 50 tokens to be paid to person A as the remaining payment amount and handling the deposit balance of person C as 50 tokens.

Next, the payment smart contract for person C updates the remaining payment amount (disbursement) (S266). Here, the payment smart contract for person C updates the remaining payment amount that is to be paid to person A into zero because the remaining payment amount of 50 tokens to be paid to person A can be handled as having been paid in full.

Next, the payment smart contract for person C closes itself so as not to be executed afterward (S267) and executes a payment smart contract for person A (S268).

More specifically, the payment smart contract for person C executes the payment SC management smart contract. Next, the executed payment SC management smart contract identifies (searches for) a payment smart contract that include person A who is the payment destination as a payment source and returns the address of the payment smart contract for person A to the payment smart contract for person C. The payment smart contract for person A as used herein refers to the first smart contract that pays the remaining payment amount of 20 tokens from the account of person A to the account of person B. Next, the payment smart contract for person C executes the payment smart contract for person A. In other words, for example, when the fourth token amount such as 20 tokens has been paid to the first account of the first user, the second smart contract that is the payment smart contract for person C executes the payment SC management smart contract. Then, the payment SC management smart contract confirms whether the list includes the remaining payment information on the first user, and if there is the remaining payment information on the first user in the list, notifies the second smart contract of a first smart contract that corresponds to the remaining payment information on the first user. The second smart contract executes the first smart contract in accordance with the result of notification from the payment SC management smart contract.

Note that the payment smart contract for person A that is executed in chained sequence pays the remaining payment amount of 20 tokens that are to be paid to person B, out of 50 tokens paid from person C. Since the remaining payment amount of 20 tokens that are to be paid to person B has been paid in full, the payment smart contract for person A updates the remaining payment amount that is to be paid to person B into zero and executes the payment SC management smart contract. Then, the payment SC management smart contract deletes, from the list, the remaining payment information indicating that person A needs to pay 20 tokens to person C.

In other words, since the third token amount that is the remaining payment amount to be paid to the second user is smaller than the fourth token amount that has become the balance in the first account of the first user, the first smart contract executed in chained sequence pays the third token amount to the second account of the second user. When having confirmed that the remaining payment amount to be paid to the first user becomes zero as a result of the first smart contract having paid the third token amount to the second account, the payment SC management smart contract deletes the remaining payment information on the first user from the list.

Although the case has been described above in which the fourth token amount (50 tokens) that exceeds the third token amount (20 tokens) indicating the remaining payment amount to be paid to person B has been paid from person C to person A, the present disclosure is not limited to this example. A case is also conceivable in which the fourth token amount that is smaller than the third token amount as the remaining payment amount to be paid to person B may be paid from person C to person A. In this case, the first smart contract, i.e., the payment smart contract for person A, may perform processing similar to the processing performed in step S16 in FIG. 7A. That is, when the third token amount is greater than the fourth token amount that has become the balance in the first account of the first user, the first smart contract may pay the fourth token amount to the second account of the second user. The first smart contract also calculates a fifth token amount as a remaining payment amount by deducting the fourth token amount from the third token amount and executes the payment SC management smart contract. Then, the payment SC management smart contract updates the remaining payment information in the list, the remaining payment information associating the first address indicating the first user, the second address indicating the second user, the address indicating the first smart contract, and information indicating that the first user needs to pay the fifth token amount as the remaining payment amount to be paid to the second user with one another.

### 3 Advantageous Effects of Embodiment

According to the present embodiment, even if the remaining payment amount is greater than the balance in the first account of the first user who has to make a payment, it is possible to cause the first user to once pay the total amount of the balance in the first account and, when money is later added into the account of the first user, to cause the first user to pay part or all of the added amount. That is, even if the remaining payment amount exceeds the payable balance in the account of the first user, it is possible by using the smart contract technology to cause the first user to later pay an amount corresponding to the insufficient amount when money is added into the account of the first user.

This allows payments to proceed properly depending on the account status of each person who has to make a payment

Moreover, according to the present embodiment, it is possible, by using the management smart contract different from smart contracts that are executed to make actual payments, to manage remaining payment amounts and smart contracts that pay the remaining payment amounts.

Moreover, according to the present embodiment, a smart contract that makes a given payment executes the management smart contract, causes the management smart contract to identify a smart contract that makes a different payment, and acquires information such as the address of the smart contract that makes the different payment. Then, the smart contract that makes the given payment executes the smart contract that makes the different payment. That is, smart contracts are executed in chained sequence by using the smart contract technology. This allows payment to proceed properly depending on the account status of each person who has to make a payment.

Moreover, according to the present embodiment, if the updated remaining payment amount exceeds the balance of money input into the account of the first user, it is possible by using the first smart contract to cause the first user to once pay the total amount of the balance in the first account of the first user.

Accordingly, it is possible by using the management smart contract to manage remaining payment amounts and smart contracts that pay the remaining payment amounts.

### 4 Other Variations

Although the present disclosure has been described based on the embodiment described above, it goes without saying that the present disclosure is not limited to the embodiment described above. The following cases are also included in the present disclosure.

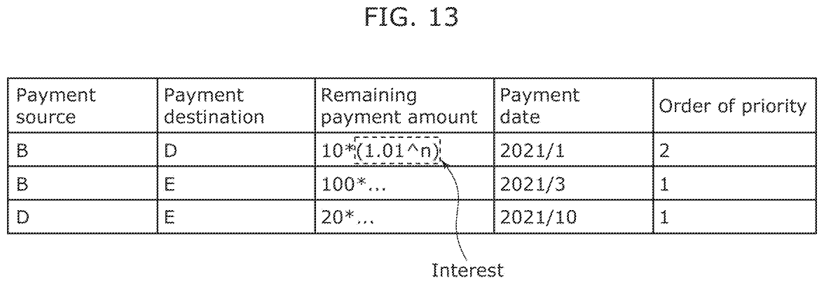

(1) FIG. 13 is a diagram showing one example of a list managed by a payment SC management smart contract according to a variation.

Although the above embodiment has been described on the assumption that the remaining payment amounts included in the list managed by the payment SC management smart contract remain unchanged unless otherwise updated, the present disclosure is not limited to this example. As illustrated in FIG. 13, the remaining payment amounts may vary according to interests to be incurred. In other words, interests incurred for each predetermined period of time may be added to the remaining payment amounts.

Moreover, although the above embodiment has been described on the assumption that payment smart contracts are executed, starting from the one that corresponds to the remaining payment information indicated by the highest-order row in the list managed by the payment SC management smart contract, the present disclosure is not limited to this example. As illustrated in FIG. 13, the order of priority may be added to the remaining payment information on the same payment source, and payment smart contracts for the same payment source may be executed in the order or priority, irrespective of the higher- or lower-order rows. In other words, the remaining payment information included in the list may further include the order of priority. In this case, when the list includes two or more remaining payment information items on the same user, the payment SC management smart contract may execute the smart contracts, starting from the one that corresponds to the remaining payment information with the highest order of priority.

(2) Although the above embodiment has been described on the assumption that smart contracts that are executed in chained sequence are executed as small tasks by a payment smart contract that is executed upon storage of transaction data in the distributed ledger, the present disclosure is not limited to this example. That is, although the above description is given on the assumption that the payment smart contract executes therein the payment SC management smart contract and other payment smart contracts, the present disclosure is not limited to this example. The payment smart contract may only generate transaction data for use in executing the payment SC management smart contract and other payment smart contracts. In this case, smart contracts that are executed in chained sequence are executed by executing the payment SC management smart contract and other payment smart contracts, using the storage of the generated transaction data in the distributed ledger as a trigger.

(3) Although the above embodiment has been described on the assumption that, when there is a remaining payment amount, the payment smart contract updates a variable that indicates the remaining payment amount and that is managed on the memory, the present disclosure is not limited to this example. When there is a remaining payment amount, the payment smart contract may close itself and generate a new payment smart contract that includes the remaining payment amount as a variable.

(4) Although the above embodiment has been described on the assumption that, when the remaining payment amount is greater than the balance in the account of a person who has to make a payment, the total amount of the balance in the account is once paid, the present disclosure is not limited to this example. Only a preset upper-limit amount, i.e., only part of the balance in the account, may be paid once. Moreover, when the remaining payment amount is greater than the balance in the account of a person who has to make a payment, no payment may be made and the remaining payment amount may be paid only when the balance in the account of a person who has to make a payment is greater than or equal to the remaining payment amount.

(5) Although the above embodiment has been described on the assumption that the balance in the account of a person who has to make a payment indicates a value greater than or equal to zero, i.e., a value of zero or a plus value, the present disclosure is not limited to this example, and a minus value may be allowed. Since it is possible to determine a payable amount in accordance with information such as the reliability of a person who has to make a payment, the balance in the account of a person who has to make a payment may be allowed to take a minus value after a lower limit of the minus value is determined.

(6) Each device according to the above-described embodiment may specifically be a computer system that includes, for example, a microprocessor, a ROM, a RAM, a hard disk unit, a display unit, a keyboard, and a mouse. The RAM or the hard disk unit stores computer programs. Each device achieves its functions as a result of the microprocessor operating in accordance with the computer programs. The computer programs as used herein refer to those configured by combining a plurality of instruction codes that indicate commands given to the computer in order to achieve predetermined functions.

(7) Some or all constituent elements that configure each device according to the above-described embodiment may be made up of a single-system large scale integrated (LSI) circuit. The system LSI circuit is a ultra-multifunction LSI circuit manufactured by integrating a plurality of components on a single chip, and is specifically a computer system that includes, for example, a microprocessor, a ROM, and a RAM. The RAM stores computer programs. The system LSI circuit achieves its functions as a result of the microprocessor operating in accordance with the computer programs.

Each part of constituent elements that configure each device described above may be formed individually into a single chip, or may be formed into a single chip so as to include some or all of the constituent elements.

Although system LSI is used as an example, the system LSI may also be referred to as IC, LSI, super LSI, or ultra LSI depending on the degree of integration. The method of circuit integration is not limited to LSI, and may be embodied in a dedicated circuit or a general-purpose processor. After the manufacture of LSI, a field programmable gate array (FPGA) capable of programming or a reconfigurable processor capable of reconfiguring connections or settings of circuit cells inside LSI may be used.

Moreover, if other circuit integration technology that replaces LSI makes its debut with the advance of semiconductor technology or with derivation from another technology, such technology may be used to integrate functional blocks. For example, the application of biotechnology is conceivable.

(8) Some or all constituent elements that configure each device described above may be configured as a stand-alone module or as an IC card that is attachable to and detachable from the device. The IC card or the module may be a computer system that includes, for example, a microprocessor, a ROM, and a RAM. The IC card or the module may include the ultra-multifunctional LSI described above. The IC card or the module achieves its functions as a result of the microprocessor operating in accordance with the computer programs. The IC card or the module may be tamper-resistant.

(9) The present disclosure may be embodied in the method described above. The present disclosure may also be embodied in a computer program for causing a computer to execute the method described above, or may be embodied in digital signals used in the computer programs.

The present disclosure may be embodied by recording the computer programs or digital signals described above on a computer-readable recording medium such as a flexible disk, a hard disk, a CD-ROM, an MO, a DVD, a DVD-ROM, a DVD-RAM, a Blu-ray disc (BD: registered trademark), or a semiconductor memory. The present disclosure may also be embodied in the digital signals recorded on such a recording medium.

The present disclosure may also be embodied in means for transmitting the computer programs or digital signals described above via, for example, telecommunication lines, wireless or wired communication lines, a network represented by the Internet, or data broadcasting.

The present disclosure may also be embodied in a computer system that includes a microprocessor and memory, in which the memory may record the computer programs described above and the microprocessor may operate in accordance with the computer programs described above.

The present disclosure may also be embodied in another independent computer system by transferring the aforementioned programs or digital signals recorded on the recording medium described above or by transferring the aforementioned programs or digital signals via the network or the like.

(10) The above-described embodiment and variations may be combined with one another.

### INDUSTRIAL APPLICABILITY

The present disclosure is applicable to a control method, a server, and a recording medium that use smart contract technology to allow proper payments to proceed automatically depending on the account status of each person who has to make a payment.

1. A control method for controlling a server that manages a transaction by using a distributed ledger, the control method comprising:
acquiring first transaction data by the server, the first transaction data indicating a transfer of a first amount from a first account of a first user to a second account of a second user, the first amount indicating a remaining transfer amount;
storing the first transaction data in the distributed ledger by the server;
executing a first program by the server upon storage of the first transaction data in the distributed ledger;
determining whether the first amount is greater than a second amount that indicates a balance in the first account and transferring the second amount to the second account when the first amount is greater than the second amount, the determining and the transferring being performed by the first program;
acquiring second transaction data and storing the second transaction data in the distributed ledger by the server, the second transaction data indicating a transfer of a fourth amount from a third account of a third user to the first account, the third user being different from the first user and the second user;
executing a second program by the server upon storage of the second transaction data in the distributed ledger;
transferring the fourth amount from the third account to the first account by the second program; and
transferring all or part of the fourth amount to the second account by the first program.

2. The control method according to claim 1,
wherein, when the first amount is greater than the second amount, the first program transfers the second amount to the second account and calculates a third amount by deducting the second amount from the first amount as a remaining transfer amount to be transferred to the second user,
after calculation of the third amount, the first program executes a management program stored in the distributed ledger, the management program being a contract to manage a list on memory, the list including, as variables, information on a transfer source, information on a transfer destination, and information on a program to make a transfer from the transfer source to the transfer destination, and
the management program adds remaining transfer information to the list, the remaining transfer information being information in which a first address indicating the first user, a second address indicating the second user, an address indicating the first program, and information indicating that the first user needs to transfer the third amount as the remaining transfer amount to the second user are associated with one another.

3. The control method according to claim 2,
wherein, when the fourth amount is transferred to the first account, the second program executes the management program,
the management program confirms whether the list includes the remaining transfer information on the first user and, when the list includes the remaining transfer information on the first user, the management program notifies the second program of the first program that corresponds to the remaining transfer information on the first user, and
the second program executes the first program in accordance with a result of notification from the management program.

4. The control method according to claim 3,
wherein, when the third amount is smaller than the fourth amount that has become the balance in the first account, the first program transfers the third amount to the second account.

5. The control method according to claim 4,
wherein, when having confirmed that a remaining transfer amount to be transferred by the first user becomes zero as a result of the transfer of the third amount to the second account by the first program, the management program deletes the remaining transfer information on the first user from the list.

6. The control method according to claim 3,
wherein, when the third amount is greater than the fourth amount that has become the balance in the first account, the first program transfers the fourth amount to the second account.

7. The control method according to claim 6,
wherein, when the third amount is greater than the fourth amount, the first program transfers the fourth amount to the second account and calculates a fifth amount by deducting the fourth amount from the third amount as a remaining transfer amount to be transferred to the second user,
after calculation of the fifth amount, the first program executes the management program, and
the management program updates the list in accordance with remaining transfer information in which the first address indicating the first user, the second address indicating the second user, the address indicating the first program, and information indicating that the first user needs to transfer the fifth amount as the remaining transfer amount to the second user are associated with one another.

8. The control method according to claim 2,
wherein the remaining transfer information included in the list further includes an order of priority, and
when the list includes two or more remaining transfer information items on one user, the management program executes programs, starting from a program that corresponds to remaining transfer information with a highest order of priority.

9. The control method according to claim 1,
wherein an interest incurred for each predetermined period of time is added to the remaining transfer amount.

10. A server for managing a transaction by using a distributed ledger, the server comprising:
a processor; and
memory,
wherein, using the processor and the memory, the server:
acquires first transaction data that indicates a transfer of a first amount from a first account of a first user to a second account of a second user, the first amount indicating a remaining transfer amount;
stores the first transaction data in the distributed ledger;
executes a first program upon storage of the first transaction data in the distributed ledger;
causes the first program to determine whether the first amount is greater than a second amount that indicates a balance in the first account and transfer the second amount to the second account when the first amount is greater than the second amount;
causes the processor to acquire second transaction data and store the second transaction data in the distributed ledger, the second transaction data indicating a transfer of a fourth amount from a third account of a third user to the first account, the third user being different from the first user and the second user;
causes the processor to execute a second program upon storage of the second transaction data in the distributed ledger;
causes the second program to transfer the fourth amount from the third account to the first account; and
causes the processor to cause the first program to transfer all or part of the fourth amount to the second account.

11. A non-transitory computer-readable recording medium that stores a program for causing a computer to execute a control method for controlling a server that manages a transaction by using a distributed ledger, the control method comprising:
acquiring first transaction data that indicates a transfer of a first amount from a first account of a first user to a second account of a second user, the first amount indicating a remaining transfer amount;
storing the first transaction data in the distributed ledger;
executing a first program upon storage of the first transaction data in the distributed ledger;
causing the first program to determine whether the first amount is greater than a second amount that indicates a balance in the first account and transferring the second amount to the second account when the first amount is greater than second amount;
acquiring second transaction data and storing the second transaction data in the distributed ledger, the second transaction data indicating a transfer of a fourth amount from a third account of a third user to the first account, the third user being different from the first user and the second user;
executing a second program upon storage of the second transaction data in the distributed ledger;
causing the second program to transfer the fourth amount from the third account to the first account; and
causing the first program to transfer all or part of the fourth amount to the second account.
